(19) United States
(12) Patent Application Publication
(10) Pub. No.: US 2020/0177390 A1
(43) Pub. Date: Jun. 4, 2020

(54) PROVIDING DATA VERIFICATION IN A BLOCKCHAIN LEDGER

(71) Applicant: Alibaba Group Holding Limited, George Town (KY)

(72) Inventors: Xinxing Yang, Hangzhou (CN); Benquan Yu, Hangzhou (CN); Yize Li, Hangzhou (CN); Yuan Zhang, Hangzhou (CN); Haizhen Zhuo, Hangzhou (CN)

(73) Assignee: Alibaba Group Holding Limited, George Town (KY)

(21) Appl. No.: 16/779,498

(22) Filed: Jan. 31, 2020

Related U.S. Application Data
(63) Continuation of application No. PCT/CN2020/071884, filed on Jan. 14, 2020.

(30) Foreign Application Priority Data
Apr. 18, 2019 (CN) 201910314334.9

(51) Int. Cl. H04L 9/32; G06F 16/23; H04L 9/06

(52) U.S. Cl. CPC H04L 9/3236; H04L 2209/38; H04L 9/0637; G06F 16/2365

(57) ABSTRACT

Implementations of this specification provide a method and an apparatus for providing data verification in a blockchain ledger. An example method includes receiving, from a client and by a database server that is configured to store data using the blockchain ledger, an instruction that includes a verification method parameter and a verification range parameter for the database server. The verification method parameter is used to indicate a computing device on which verification is to be performed, and the verification range parameter includes a block height or a hash value, and is used to determine a range of a to-be-verified data block or a data record in the ledger. The database server determines the computing device on which verification is to be performed, based on the verification method parameter. The database server determines to-be-verified data based on the verification range parameter.

### CROSS-REFERENCE TO RELATED APPLICATIONS

This application is a continuation of PCT Application No. PCT/CN2020/071884, filed on Jan. 14, 2020, which claims priority to Chinese Patent Application No. 201910314334.9, filed on Apr. 18, 2019, and each application is hereby incorporated by reference in its entirety.

### TECHNICAL FIELD

Implementations of the present specification relate to the field of information technologies, and in particular, to a data verification method, system, apparatus, and device in a blockchain ledger.

### BACKGROUND

When a centralized database server stores data by using a blockchain ledger, a user often initiates various verification to the server. During verification, based on user needs, some verification needs to be completed on a client, and some verification needs to be completed on the server. In addition, verification ranges are often different.

Therefore, there is a need for a solution in which data verification can be flexibly performed in a blockchain ledger.

### SUMMARY

An objective of implementations of the present application is to provide a data verification solution in a blockchain ledger.

To alleviate the previous technical problem, the implementations of the present application are implemented as follows:

A data verification method in a blockchain ledger is applied to a system including a database server and a client, where the database server stores data by using the blockchain ledger in a centralized way, and the method includes: sending, by the client, an instruction that includes a verification method parameter and a verification range parameter to the database server, where the verification method parameter is used to instruct to perform verification on the database server or perform verification on the client; the verification range parameter includes a block height or a hash value, and is used to determine a range of a to-be-verified data block or a data record in the ledger; determining, by the database server, to-be-verified data based on the verification range parameter, where the to-be-verified data includes one of a data record, a data block, a partial ledger, or an entire ledger; verifying, by the database server, integrity of the to-be-verified data when the verification method parameter instructs to perform verification on the database server, and returning a verification result to the client; returning, by the database server, the to-be-verified data to the client when the verification method parameter instructs to perform verification on the client, and verifying, by the client, integrity of the to-be-verified data to generate a verification result.

Correspondingly, an implementation of the present specification further provides a data verification system in a blockchain ledger. The system includes a database server and a client. The database server stores data by using the blockchain ledger in a centralized way.

In the system, the client sends an instruction that includes a verification method parameter and a verification range parameter to the database server, where the verification method parameter is used to instruct to perform verification on the database server or perform verification on the client; the verification range parameter includes a block height or a hash value, and is used to determine a range of a to-be-verified data block or a data record in the ledger; the database server determines to-be-verified data based on the verification range parameter, where the to-be-verified data includes one of a data record, a data block, a partial ledger, or an entire ledger; the database server verifies integrity of the to-be-verified data when the verification method parameter instructs to perform verification on the database server, and returns a verification result to the client; the database server returns the to-be-verified data to the client when the verification method parameter instructs to perform verification on the client, and the client verifies integrity of the to-be-verified data to generate a verification result.

Correspondingly, an implementation of the present specification further provides a data verification method in a blockchain ledger, applied to a database server that stores data by using the blockchain ledger in a centralized way, and the method includes: receiving an instruction that includes a verification method parameter and a verification range parameter, where the verification method parameter is used to instruct to perform verification on the database server or perform verification on a client; the verification range parameter includes a block height or a hash value, and is used to determine a range of a to-be-verified data block or a data record in the ledger; determining to-be-verified data based on the verification range parameter, where the to-be-verified data includes one of a data record, a data block, a partial ledger, or an entire ledger; verifying, by the database server, integrity of the to-be-verified data when the verification method parameter instructs to perform verification on the database server, and returning a verification result to the client; returning, by the database server, the to-be-verified data to the client when the verification method parameter instructs to perform verification on the client, so the client verifies integrity of the to-be-verified data.

Correspondingly, an implementation of the present specification further provides a data verification apparatus in a blockchain ledger, applied to a database server that stores data by using the blockchain ledger in a centralized way, and the apparatus includes: a receiving module, configured to receive an instruction that includes a verification method parameter and a verification range parameter, where the verification method parameter is used to instruct to perform verification on the database server or perform verification on a client; the verification range parameter includes a block height or a hash value, and is used to determine a range of a to-be-verified data block or a data record in the ledger; a determining module, configured to determine to-be-verified data based on the verification range parameter, where the to-be-verified data includes one of a data record, a data block, a partial ledger, or an entire ledger; a verification module, configured to verify, by the database server, integrity of the to-be-verified data when the verification method parameter instructs to perform verification on the database server, and return a verification result to the client; a sending module, configured to return, by the database server, the to-be-verified data to the client when the verification method parameter instructs to perform verification on the client, so the client verifies integrity of the to-be-verified data.

According to solutions provided in implementations of the present specification, when initiating a verification request, a user includes a related verification method parameter and verification range parameter to the request, so a server can determine, based on the verification method parameter, whether to perform verification on the server or on a client, and determine a verification range based on the verification range parameter, so as to execute a corresponding verification method. The implementations can flexibly implement data verification in a blockchain ledger.

It should be understood that the previous general description and the following detailed description are merely exemplary and illustrative, and does not limit the implementations of the present specification.

In addition, any one of the implementations in the present specification does not need to achieve all the previous effects.

### BRIEF DESCRIPTION OF DRAWINGS

To describe the technical solutions in the implementations of the present specification or in the existing technology more clearly, the following briefly describes the accompanying drawings needed for describing the implementations or the existing technology. Apparently, the accompanying drawings in the following description merely show some implementations of the present specification, and a person of ordinary skill in the art can still derive other drawings from these accompanying drawings.

FIG. 1 is a schematic flowchart of generating a data block in a blockchain ledger, according to an implementation of the present specification;

FIG. 2 illustrates a data verification method in a blockchain ledger, according to an implementation of the present specification;

FIG. 3 is a schematic flowchart illustrating a data verification method on a database server, according to an implementation of the present specification;

FIG. 4 is a schematic structural diagram illustrating a data verification apparatus in a blockchain ledger on a database server, according to an implementation of the present specification;

FIG. 5 is a schematic structural diagram illustrating a device used to configure a method in an implementation of the present specification.

### DESCRIPTION OF IMPLEMENTATIONS

To make a person skilled in the art better understand the technical solutions in the implementations of the present specification, the following describes in detail the technical solutions in the implementations of the present specification with reference to the accompanying drawings in the implementations of the present specification. Apparently, the described implementations are merely some but not all of the implementations of the present specification. All other implementations obtained by a person of ordinary skill in the art based on the implementations of the present specification shall fall within the protection scope of the present specification.

First, a centralized blockchain ledger in the present specification is described.

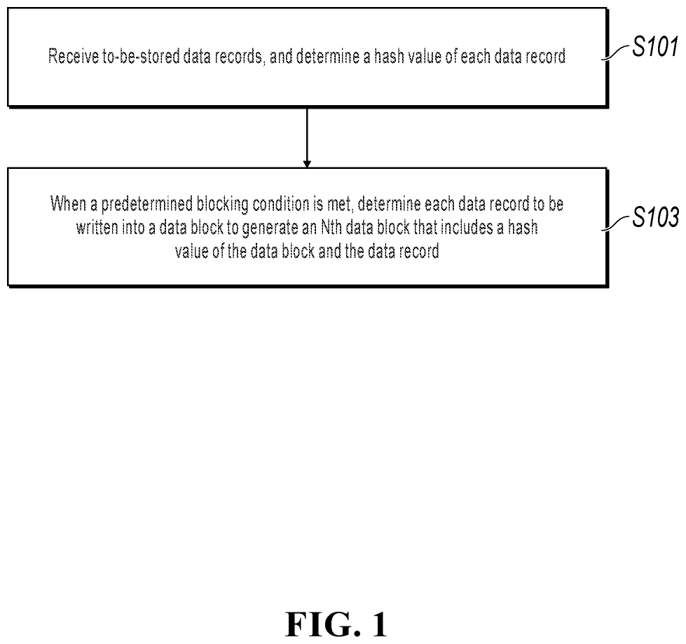

In a centralized database service provider involved in the implementations of the present specification, one ledger includes multiple data blocks, and the data blocks are pre-generated in the following way. FIG. 1 is a schematic flowchart of generating a data block in a blockchain ledger, according to an implementation of the present specification. The process includes:

S101. Receive to-be-stored data records, and determine a hash value of each data record, where the to-be-stored data records here can be various consumption records of an individual user of a client, or can be a service result, an intermediate state, an operation record, etc. that are generated when an application server executes service logic based on an instruction of the user; can include a consumption record, an audit log, a supply chain, a government supervision record, a medical record, etc. in specific service scenarios.

S103. When a predetermined blocking condition is met, determine each data record to be written into a data block to generate an Nth data block that includes a hash value of the data block and the data record.

The predetermined blocking condition includes: The number of to-be-stored data records reaches a number threshold. For example, each time one thousand data records are received, one new data block is generated, and the one thousand data records are written into the block. Or a time interval counting from a previous blocking moment reaches a time threshold. For example, one new data block is generated every five minutes, and a data record received within the five minutes is written into the block.

N refers to a serial number of a data block. In other words, in this implementation of the present specification, data blocks are arranged in a form of block-chain and in a sequence of blocking moments, and have a strong time sequence characteristic. Block heights of the data blocks are monotonically increased based on a sequence of blocking moments. The block height can be a serial number, and in this case, the block height of the Nth data block is N. The block height can also be generated in another method.

When N=1, the data block is an initial data block. A hash value and a block height of the initial data block are given based on a predetermined method. For example, the initial data block does not include a data record, a hash value is any given hash value, and a block height blknum=0. For another example, a trigger condition for generating the initial data block is consistent with a trigger condition for another data block, but the hash value of the initial data block is determined by hashing all content in the initial data block.

When N>1, because content and a hash value of a previous data block are determined, a hash value of a current data block (the Nth data block) can be generated based on the hash value of the previous data block (that is, the (N−1)th data block). For example, in a feasible method, hash values of all data records to be written into the Nth block are determined, and a Merkle tree is generated based on an arrangement sequence of the data records in the block. A root hash value of the Merkle tree is concatenated with the hash value of the previous data block to generate the hash value of the current data block by using a hash algorithm. For another example, a hash value of the entire data record can be obtained by performing concatenation and hashing based on the sequence of data records in the block. The hash value of the entire data record is concatenated with the hash value of the previous data block to obtain a character string. A hash operation is performed on the character string to generate the hash value of the data block.

When a server generates one data block and writes the data block into the ledger, a hash value of the data block and a hash value of each data record in the data block can be returned to a client.

According to the previous data block generation method, each data block is determined by using a hash value, and the hash value of the data block is determined by content and a sequence of data records in the data block, and a hash value of a previous data block. The user can initiate verification at any time based on the hash value of the data block. Modification to any content in the data block (including the content or the sequence of data records in the data block) causes a difference between a hash value of the data block calculated during verification and a hash value of the data block during generation, which causes a verification failure, thereby avoiding tampering in the centralized scenario.

Specifically, integrity of a data record is verified by obtaining the data record and determining a hash value of the data record and a hash value of another data record in a data block in which the data record is located, to form a Merkle tree and verify whether a root hash of the Merkle tree can be regenerated. A data block is verified by recalculating a hash value of the data block based on a hash value of a previous data block and a data record of the data block, and verifying whether the hash value is consistent with a previously calculated hash value. In addition, the data record corresponding to the hash value can be directly returned to the user, so the user can directly perform a hash operation on the data record to verify integrity.

As described above, after the data of the user is stored in the ledger, the user can initiate verification to the server. It is worthwhile to note that, in the implementation of the present specification, although the blockchain ledger is similar to a blockchain, in the implementation of the present specification, the database server provides services externally in a centralized way, which is essentially different from the blockchain.

In a blockchain system, because services are de-centralized, a client can initiate data verification to any node that has permission to perform verification. The blockchain system can ensure consistency of data returned by all nodes. A user can trust a result returned by the node. In other words, the client does not need to locally perform data verification.

However, in the implementation of the present specification, the database server is in a centralized way. Therefore, if both data storage and data verification are completed on the server, a result is not necessarily trustworthy for a user. Therefore, some users hope to complete corresponding data verification on the client.

In addition, in a blockchain ledger, some verification resources are less consumed, such as verifying whether a data record exists in the ledger. However, some verification resources are greatly consumed, such as verifying data integrity of an entire ledger. It can be difficult for some client devices to support the greatly consumed resources.

Accordingly, an implementation of the present specification provides a solution in which flexible data verification can be performed in a blockchain ledger.

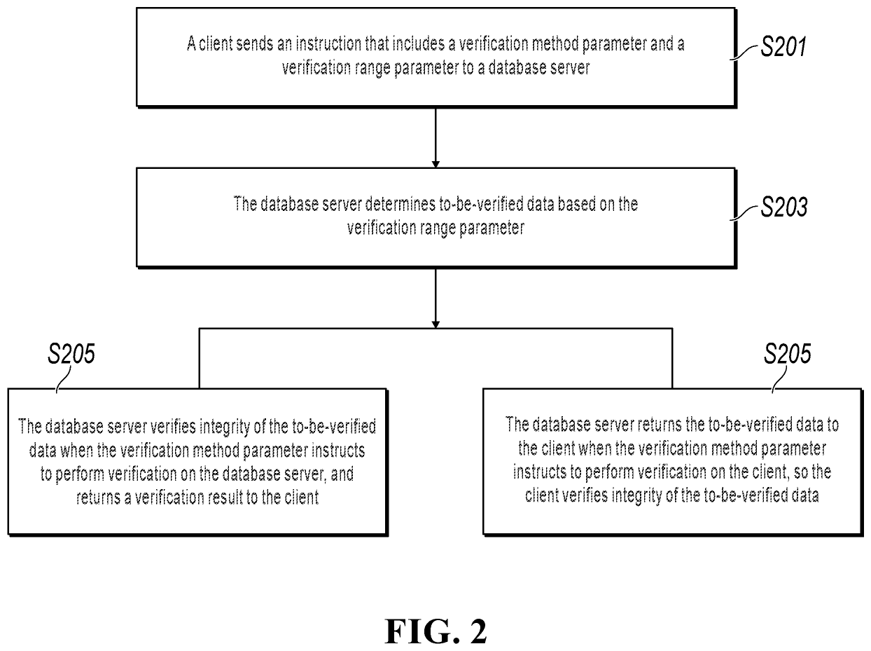

The technical solutions provided in the implementations of the present specification are described in detail below with reference to the accompanying drawings. FIG. 2 illustrates a data verification method in a blockchain ledger, according to an implementation of the present specification. The method is applied to a system including a database server and a client. The database server stores data by using the blockchain ledger in a centralized way. The process specifically includes the following steps:

S201. The client sends an instruction that includes a verification method parameter and a verification range parameter to the database server.

Specifically, a user can initiate a verification instruction by using the client, and the verification instruction specifies, by using the verification range parameter, data blocks on which verification is initiated. The verification range parameter can be a block height or a hash value.

For example, a data block can be specified by using a hash value to initiate verification on the data block. Or a value is further added to specify whether correct verification is initiated on multiple data blocks before or after the data block. Or a data record is specified by using a hash value to verify whether the data record exists in a database.

In addition, the verification instruction can further include the verification method parameter, where the verification method parameter is used to indicate the user's needs, and instruct to perform current verification on the database server or on the client. It is worthwhile to note that the verification instruction can include only the verification range parameter, and the verification method parameter can be omitted. In this case, a default verification method is performed on the server.

The following provides examples of several verification instruction forms provided in the implementation of the present specification, and the verification method is omitted.

Example 1: The instruction includes a hash value of the verification range parameter, and the hash value corresponds to a data record or a certain data block. The server verifies the data block to obtain a verification result. Specifically, a verification instruction VERIFY(‘khash’, &v) can be used for implementation. “khash” is a hash value entered by the user, “&v” is a return result of current verification, and after verification ends, the server assigns a value to “&v”.

Example 2: The instruction includes a hash value of the verification range parameter, and the hash value is used to determine a corresponding data block, or is used to determine a data block in which a data record corresponding to the hash value is located. The verification instruction is used to perform verification forward starting from the determined data block until an initial data block. Specifically, verification instruction VERIFY(‘khash’, &v, −1) can be used for implementation. Generally, an initial block height is “0” or “1”. Therefore, −1 can also be another value that is less than the initial block height. Therefore, a serving party can know that this parameter is not a very small block height value, which means that verification continues unit the initial data block.

Example 3: The instruction includes a hash value of the verification range parameter, and the hash value is used to determine a corresponding data block. A specified number of data blocks are verified forward starting from the determined data block. Specifically, verification instruction VERIFY(‘khash’, &v, blknum) can be used for implementation, where khash is a hash value entered by the user, and “blknum” is the number of to-be-verified data blocks specified by the user.

Example 4: The instruction includes a block height of the verification range parameter, and a specified number of consecutive data blocks are verified forward starting from a data block corresponding to the block height. Specifically, verification instruction VERIFY(blkh, &v, blknum) can be used for implementation. “blkh” is a hash value entered by the user, “blknum” is the number of to-be-verified data blocks specified by the user, and blknum can be 1 or omitted, that is, only one data block is verified currently. Or blknum can be a large number. If the value of blknum exceeds the ledger number in the ledger, it indicates that entire ledger verification needs to be performed for current verification.

Example 5: The instruction includes two block height values of the verification range parameter. Specifically, verification instruction VERIFY(blkh1, blkh2, &v) can be used for implementation, where blkh1 and blkh2 are used to determine a block height interval of a data block in current verification.

Further, in the verification instruction, the verification method parameter can be added to determine to perform verification on the server or on the client.

For example, after the verification method parameter is added, the first verification instruction becomes VERIFY(Remote, ‘khash’, &v) or VERIFY(Client, ‘khash’, &v). “Remote” indicates that current verification is performed on the server, and “Client” indicates that the current verification is performed on the client.

For another example, after the verification method parameter is added, the fourth verification instruction becomes VERIFY(Client, blkh, &v, 1), indicating that current verification on a data block with a certain block height is completed on the client.

S203. The database server determines to-be-verified data based on the verification range parameter, where the to-be-verified data includes one of a data record, a data block, a partial ledger, or an entire ledger.

In the blockchain ledger, a hash value can uniquely represent one data record or one data block, and the block height can also uniquely identify one data block. Therefore, based on the verification range parameter, to-be-verified data corresponding to a current instruction can always be determined.

“Corresponds to” in this implementation of the present specification means that a hash value can be obtained by performing a hash operation on a data record or a data block, and a correspondence exists between the hash value and the data record or the data block.

Specifically, after receiving the verification instruction, the database server can parse the instruction to obtain a hash value or a block height of a corresponding verification range parameter. Further, the database server can perform traversal query to verify whether the hash corresponds to a certain data record or data block; or query and obtain a block height and an offset that correspond to the hash value from an index table, and then obtain a corresponding data record based on the read block height and offset.

For example, for the first verification instruction that includes the hash value, that is, VERIFY(Remote, ‘khash’, &v), the server obtains the hash value of the instruction and performs matching query on the hash value in a pre-established data record index table (data record hash value, block height, offset in a block height), to obtain a block height and an offset of a data block in which the data record is located, further determine a data record corresponding to the hash value, and determine the data record as to-be-verified data.

It is worthwhile to note that, in the instruction, the user does not need to specify “khash” as the hash value of the data record or the hash value of the data block. The server can obtain through querying, in a traversal way, an object corresponding to the hash value from the ledger, or obtain through querying, from a pre-established data record hash index/data block hash index (including a correspondence between a data block hash value and a data block height), the object corresponding to the hash value.

For another example, for the fifth instruction that includes the data block height, that is, VERIFY(Client, 100, 300, &v), the database server can determine a block height interval [100, 300] based on block heights 100 and 300, and determine a partial ledger corresponding to a data block whose block height falls into the interval as to-be-verified data.

S205. Verify integrity of the to-be-verified data.

Specifically, the database server verifies the integrity of the to-be-verified data when the verification method parameter instructs to perform verification on the database server, and returns a verification result to the client. The verification result can be displayed by assigning a value to “&v” in the verification instruction.

The database server returns the to-be-verified data to the client when the verification method parameter instructs to perform verification on the client, and the client verifies integrity of the to-be-verified data to generate a verification result. A specific method for verifying integrity of the data record or the ledger is described in the previous description, and details are omitted here.

According to solutions provided in implementations of the present specification, when initiating a verification request, a user includes a related verification method parameter and verification range parameter to the request, so a server can determine, based on the verification method parameter, whether to perform verification on the server or on a client, and determine a verification range based on the verification range parameter, so as to execute a corresponding verification method. The implementations can flexibly implement data verification in a blockchain ledger.

In an implementation, further an indicative prefix or suffix field can be added to the verification method parameter, so the server can more effectively parse the instruction.

For example, prefix Tx is added to the verification method to indicate that current verification is performed for a data record on the client, and a form of the verification instruction is therefore VERIFY(TxClient, khash, &v), so the server can directly query a data record corresponding to khash.

In an implementation, when the verification method parameter instructs to perform verification on the client, and there is related data for verification on the client, the server only needs to send the to-be-verified data.

In an implementation, when determining the to-be-verified data, the database server can further determine, based on an operation instruction, other auxiliary verification data needed for verification, and send the other auxiliary verification data to the client.

For example, when the user initiates the fourth verification instruction to verify a specified data block, VERIFY(Client, blkh, &v, 1) indicates that a data block specified by a block height blkh needs to be verified on the client. The database server can obtain through matching a corresponding data block as the to-be-verified data based on the block height blkh. In addition, in the process of verifying a data block, a hash value of a previous data block of the data block needs to be used. Therefore, the database server can further obtain “the hash value of the previous data block” as auxiliary verification data and directly send the auxiliary verification data to the client.

For another example, when the user initiates the first verification instruction (refer to example 1), that is, VERIFY(Client, ‘khash’, &v), whether a specified data record exists in the ledger is verified on the client. During the verification, a Merkle tree consisting of data records in a data block needs to be first determined, so as to determine a Merkle path of the data record in the Merkle tree. In other words, a hash value of another data record on the Merkle path and a root hash of the Merkle tree need to be used. In this case, the database server can send the hash value of the another data record on the Merkle path and the root hash of the Merkle tree to the client as auxiliary verification data, or directly send content of the entire data block to the client as sufficient verification data (generally, when the user that initiates verification has permission to access all the content).

In practice, when resources are insufficient on the client, a selective check can be performed randomly on a data block in the ledger. For example, a data block height is randomly specified for verification on the client. Or several hash values are selected to perform existence verification on data records corresponding to the hash values on the client. When the above-mentioned selective check and verification are passed, verification is initiated on a partial ledger or the entire ledger on the server. Certainly, when resources are sufficient, the server can also be requested to deliver data and perform verification on the entire ledger locally. As such, in a centralized scenario, the user's requirements on integrity of the ledger are met, and flexible verification on the centralized ledger is implemented.

Correspondingly, an implementation of the present specification further provides a data verification system in a blockchain ledger. The system includes a database server and a client. The database server stores data by using the blockchain ledger in a centralized way.

In the system, the client sends an instruction that includes a verification method parameter and a verification range parameter to the database server, where the verification method parameter is used to instruct to perform verification on the database server or perform verification on the client; the verification range parameter includes a block height or a hash value, and is used to determine a range of a to-be-verified data block or a data record in the ledger; the database server determines to-be-verified data based on the verification range parameter, where the to-be-verified data includes one of a data record, a data block, a partial ledger, or an entire ledger; the database server verifies integrity of the to-be-verified data when the verification method parameter instructs to perform verification on the database server, and returns a verification result to the client; the database server returns the to-be-verified data to the client when the verification method parameter instructs to perform verification on the client, and the client verifies integrity of the to-be-verified data to generate a verification result.

Further, in the system, when the verification range parameter is the hash value, the database server queries and obtains a data record corresponding to the hash value, and determines the data record and/or a data block in which the data record is located as the to-be-verified data; or the database server queries and obtains a data block corresponding to the hash value, and determines the data block as the to-be-verified data.

Further, in the system, when the verification range parameter is the block height, the database server determines a data block corresponding to the block height, and determines the data block as the to-be-verified data; or the database server determines a partial or an entire ledger corresponding to an interval formed by two block heights, and determines the partial or the entire ledger as the to-be-verified data.

Further, in the system, when the verification method parameter instructs to perform verification on the client, the database server determines other auxiliary verification data needed when the client verifies the to-be-verified data, and sends the to-be-verified data and the other auxiliary verification data to the client.

Further, on the centralized database server, the data block is pre-generated by: receiving to-be-stored data records and determining a hash value of each data record, where the data record includes a specified identifier field; when a predetermined blocking condition is met, determining each data record to be written into a data block to generate an Nth data block that includes a hash value of the data block and the data record, which specifically includes: when N=1, giving a hash value and a block height of an initial data block based on a predetermined method; when N>1, determining a hash value of the Nth data block based on each data record to be written into the data block and a hash value of an (N−1)th data block, generate the Nth data block that includes the hash value of the Nth data block and each data record, where block heights of data blocks are increased monotonically based on a sequence of blocking moments.

Further, in the system, the predetermined blocking condition includes: the number of to-be-stored data records reaches a number threshold; or a time interval counting from a previous blocking moment reaches a time threshold.

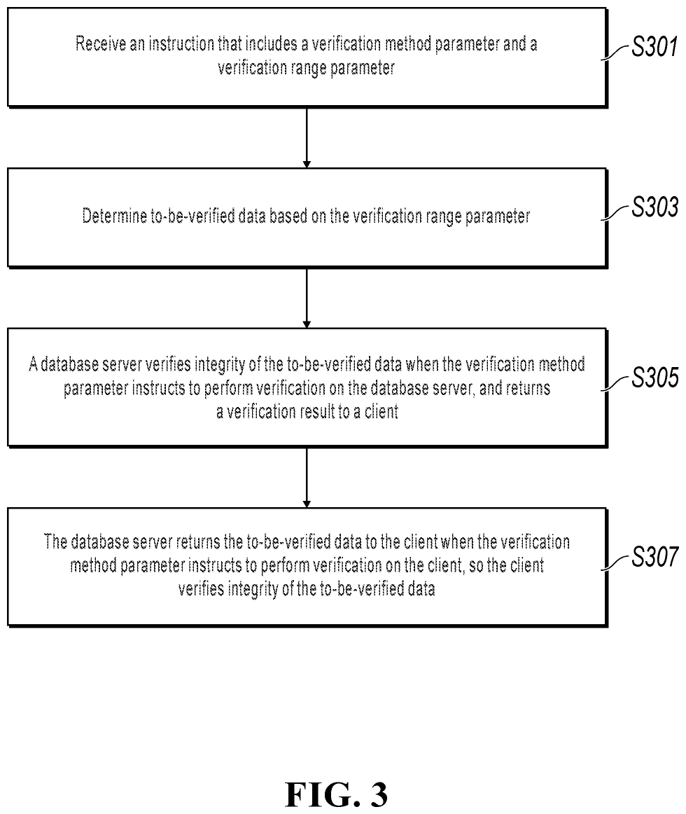

Correspondingly, an implementation of the present specification further provides a data verification method in a blockchain ledger. The method is applied to a database server that stores data by using the blockchain ledger in a centralized way. FIG. 3 is a schematic flowchart illustrating a data verification method on a database server, according to an implementation of the present specification. The method includes:

S301. Receive an instruction that includes a verification method parameter and a verification range parameter, where the verification method parameter is used to instruct to perform verification on the database server or perform verification on a client; the verification range parameter includes a block height or a hash value, and is used to determine a range of a to-be-verified data block or a data record in the ledger.

S303. Determine to-be-verified data based on the verification range parameter, where the to-be-verified data includes one of a data record, a data block, a partial ledger, or an entire ledger.

S305. The database server verifies integrity of the to-be-verified data when the verification method parameter instructs to perform verification on the database server, and returns a verification result to the client.

S307. The database server returns the to-be-verified data to the client when the verification method parameter instructs to perform verification on the client, so the client verifies integrity of the to-be-verified data.

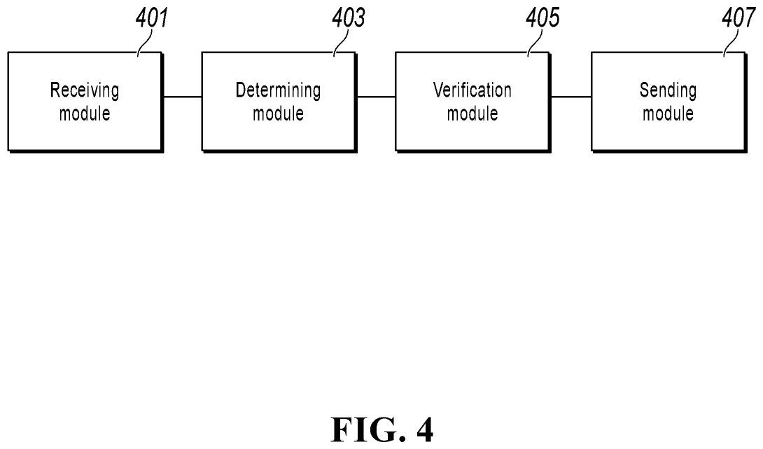

Correspondingly, an implementation of the present specification further provides a data verification apparatus in a blockchain ledger. FIG. 4 is a schematic structural diagram illustrating a data verification apparatus in a blockchain ledger on a database server, according to an implementation of the present specification. The apparatus includes: a receiving module 401, configured to receive an instruction that includes a verification method parameter and a verification range parameter, where the verification method parameter is used to instruct to perform verification on the database server or perform verification on a client; the verification range parameter includes a block height or a hash value, and is used to determine a range of a to-be-verified data block or a data record in the ledger; a determining module 403, configured to determine to-be-verified data based on the verification range parameter, where the to-be-verified data includes one of a data record, a data block, a partial ledger, or an entire ledger; a verification module 405, configured to verify, by the database server, integrity of the to-be-verified data when the verification method parameter instructs to perform verification on the database server, and return a verification result to the client; a sending module 407, configured to return, by the database server, the to-be-verified data to the client when the verification method parameter instructs to perform verification on the client, so the client verifies integrity of the to-be-verified data.

An implementation of the present specification further provides a computer device. The computer device includes at least a memory, a processor, and a computer program that is stored in the memory and that can run on the processor. When executing the program, the processor implements the data verification method in a blockchain ledger shown in FIG. 2.

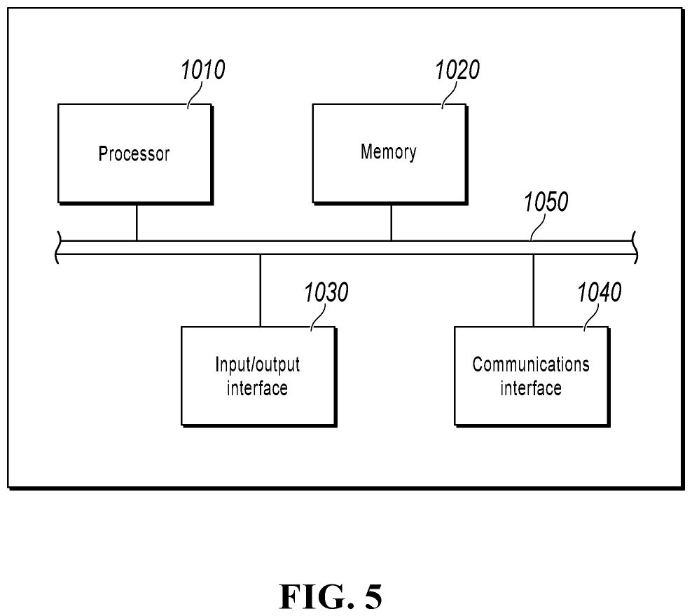

FIG. 5 is a more detailed schematic diagram illustrating a hardware structure of a computing device, according to an implementation of the present specification. The device can include a processor 1010, a memory 1020, an input/output interface 1030, a communications interface 1040, and a bus 1050. The processor 1010, the memory 1020, the input/output interface 1030, and the communications interface 1040 are communicatively connected to each other inside the device by using the bus 1050.

The processor 1010 can be implemented by using a general central processing unit (CPU), a microprocessor, an application-specific integrated circuit (ASIC), one or more integrated circuits, etc., and is configured to execute a related program, so as to implement the technical solutions provided in the implementations of the present specification.

The memory 1020 can be implemented by using a read-only memory (ROM), a random access memory (RAM), a static storage device, a dynamic storage device, etc. The memory 1020 can store an operating system and another application program. When the technical solutions provided in the implementations of the present specification are implemented by using software or firmware, related program code is stored in the memory 1020, and is invoked and executed by the processor 1010.

The input/output interface 1030 is configured to be connected to an input/output module, to input or output information. The input/output module (not shown in the figure) can be used as a component and configured in the device, or can be externally connected to the device, to provide a corresponding function. The input module can include a keyboard, a mouse device, a touchscreen, a microphone, various sensors, etc. The output module can include a monitor, a speaker, a vibrator, an indicator, etc.

The communications interface 1040 is configured to be connected to a communications module (not shown in the figure), to implement a communication interaction between the device and another device. The communications module can perform communication in a wired way (for example, USB or a network cable), or can perform communication in a wireless way (for example, a mobile network, Wi-Fi, or Bluetooth).

The bus 1050 includes one channel, used to transmit information between components (for example, the processor 1010, the memory 1020, the input/output interface 1030, and the communications interface 1040) of the device.

It is worthwhile to note that although only the processor 1010, the memory 1020, the input/output interface 1030, the communications interface 1040, and the bus 1050 of the device are shown, during specific implementation, the device can further include other components needed for implementing normal running. In addition, a person skilled in the art can understand that the device can include only components necessary for implementing the solutions in the implementations of the present specification, but does not necessarily include all components shown in the figure.

An implementation of the present specification further provides a computer readable storage medium on which a computer program is stored. When being executed by a processor, the program implements the data verification method in a blockchain ledger shown in FIG. 2.

The computer readable medium includes persistent, non-persistent, movable, and unmovable media that can store information by using any method or technology. The information can be a computer readable instruction, a data structure, a program module, or other data. Examples of the computer storage medium include but are not limited to a phase change random access memory (PRAM), a static RAM (SRAM), a dynamic RAM (DRAM), a RAM of another type, a read-only memory (ROM), an electrically erasable programmable ROM (EEPROM), a flash memory or another memory technology, a compact disc ROM (CD-ROM), a digital versatile disc (DVD), or another optical storage, a cassette, a cassette magnetic disk storage, or another magnetic storage device or any other non-transmission medium. The computer storage medium can be configured to store information that can be accessed by a computing device. As described in the present application, the computer readable medium does not include computer readable transitory media such as a modulated data signal and a carrier.

It can be seen from the previous descriptions of the implementations that, a person skilled in the art can clearly understand that the implementations of the present specification can be implemented by using software and a necessary general hardware platform. Based on such an understanding, the technical solutions in the implementations of the present specification essentially or the part contributing to the existing technology can be implemented in a form of a software product. The computer software product can be stored in a storage medium, such as a ROM/RAM, a magnetic disk, or an optical disc, and includes several instructions for instructing a computer device (which can be a personal computer, a server, a network device, etc.) to perform the method described in the implementations of the present specification or in some parts of the implementations of the present specification.

The system, method, module, or unit illustrated in the previous implementations can be implemented by using a computer chip or an entity, or can be implemented by using a product having a certain function. A typical implementation device is a computer, and the computer can be a personal computer, a laptop computer, a cellular phone, a camera phone, a smartphone, a personal digital assistant, a media player, a navigation device, an email receiving and sending device, a game console, a tablet computer, a wearable device, or any combination of these devices.

The implementations in the present specification are described in a progressive way. For same or similar parts of the implementations, references can be made to the implementations. Each implementation focuses on a difference from other implementations. Particularly, a device implementation is similar to a method implementation, and therefore is described briefly. For a related part, references can be made to some descriptions in the method implementation. The previously described apparatus implementations are merely examples. The modules described as separate parts can or cannot be physically separate. During implementation of the solutions in the implementations of the present application, functions of the modules can be implemented in one or more pieces of software and/or hardware. Some or all of the modules can be selected based on an actual need to implement the solutions of the implementations. A person of ordinary skill in the art can understand and implement the implementations of the present application without creative efforts.

The previous descriptions are merely specific implementations of the implementations of the present application. It is worthwhile to note that a person of ordinary skill in the art can further make several improvements or polishing without departing from the principle of the implementations of the present application, and the improvements or polishing shall fall within the protection scope of the implementations of the present application.

What is claimed is:

1. A computer-implemented method comprising:
receiving, from a client and by a database server that is configured to store data using a blockchain ledger, an instruction that comprises a verification method parameter and a verification range parameter for the database server, wherein the verification method parameter is used to indicate a computing device on which verification is to be performed, and wherein the verification range parameter comprises a block height or a hash value, and is used to determine a range of a to-be-verified data block or a data record in the ledger;
determining, by the database server, the computing device on which verification is to be performed, based on the verification method parameter; and
determining, by the database server, to-be-verified data based on the verification range parameter, wherein the to-be-verified data comprises one of a data record, a data block, a partial ledger, or an entire ledger.

2. The method according to claim 1, further comprising:
in response to the verification method parameter indicating that verification is to be performed on the database server:
determining, by the database server, that verification is to be performed on the database server;
verifying, by the database server, integrity of the to-be-verified data; and
returning, by the database server, a verification result to the client.

3. The method according to claim 1, further comprising:
in response to the verification method parameter indicating that verification is to be performed on the client:
determining, by the database server, that verification is to be performed on the client;
sending, by the database server and to the client, the to-be-verified data for verification by the client.

4. The method according to claim 3, wherein sending the to-be-verified data for verification by the client comprises:
determining, by the database server, other auxiliary verification data for use by the client when verifying the to-be-verified data, and sending the to-be-verified data and the other auxiliary verification data to the client.

5. The method according to claim 1, wherein determining, by the database server, to-be-verified data based on the verification range parameter comprises:
in response to the verification range parameter being the hash value:
querying and obtaining, by the database server, a data record corresponding to the hash value, and determining the data record and/or a data block in which the data record is located as the to-be-verified data; or
querying and obtaining, by the database server, a data block corresponding to the hash value, and determining the data block as the to-be-verified data.

6. The method according to claim 1, wherein determining, by the database server, to-be-verified data based on the verification range parameter comprises:
in response to the verification range parameter being the block height:
determining, by the database server, a data block corresponding to the block height, and determining the data block as the to-be-verified data.

7. The method according to claim 1, wherein determining, by the database server, to-be-verified data based on the verification range parameter comprises:
in response to the verification range parameter being the block height:
determining, by the database server, a partial or an entire ledger corresponding to an interval formed by two block heights, and determining the partial or the entire ledger as the to-be-verified data.

8. The method according to claim 1, wherein on the database server, the data block is pre-generated by:
receiving to-be-stored data records and determining a hash value of each data record, wherein the data record comprises a specified identifier field; and
in response to a predetermined blocking condition being met, determining each data record to be written into a data block to generate an Nth data block that comprises a hash value of the data block and the data record.

9. The method according to claim 8, further comprising:
when N=1, giving an initial hash value and an initial block height of an initial data block based on a predetermined method.

10. The method according to claim 8, further comprising:
when N>1, determining a hash value of the Nth data block based on each data record to be written into the data block and a hash value of an (N−1)th data block, to generate the Nth data block that comprises the hash value of the Nth data block and each data record, wherein block heights of data blocks are increased monotonically based on a sequence of blocking moments.

11. The method according to claim 8, wherein the predetermined blocking condition being met comprises:
a number of to-be-stored data records reaching a number threshold.

12. The method according to claim 8, wherein the predetermined blocking condition being met comprises:
a time interval counting from a last blocking moment reaching a time threshold.

13. A computer-implemented system, comprising:
one or more computers; and
one or more computer memory devices interoperably coupled with the one or more computers and having tangible, non-transitory, machine-readable media storing one or more instructions that, when executed by the one or more computers, perform operations comprising:
receiving, from a client and by a database server that is configured to store data using a blockchain ledger, an instruction that comprises a verification method parameter and a verification range parameter for the database server, wherein the verification method parameter is used to indicate a computing device on which verification is to be performed, and wherein the verification range parameter comprises a block height or a hash value, and is used to determine a range of a to-be-verified data block or a data record in the ledger;
determining, by the database server, the computing device on which verification is to be performed, based on the verification method parameter; and
determining, by the database server, to-be-verified data based on the verification range parameter, wherein the to-be-verified data comprises one of a data record, a data block, a partial ledger, or an entire ledger.

14. The system according to claim 13, the operations further comprising:
in response to the verification method parameter indicating that verification is to be performed on the database server:
determining, by the database server, that verification is to be performed on the database server;
verifying, by the database server, integrity of the to-be-verified data; and
returning, by the database server, a verification result to the client.

15. The system according to claim 13, the operations further comprising:
in response to the verification method parameter indicating that verification is to be performed on the client:
determining, by the database server, that verification is to be performed on the client;
sending, by the database server and to the client, the to-be-verified data for verification by the client.

16. The system according to claim 15, wherein sending the to-be-verified data for verification by the client comprises:
determining, by the database server, other auxiliary verification data for use by the client when verifying the to-be-verified data, and sending the to-be-verified data and the other auxiliary verification data to the client.

17. A non-transitory, computer-readable medium storing one or more instructions executable by a computer system to perform operations comprising:
receiving, from a client and by a database server that is configured to store data using a blockchain ledger, an instruction that comprises a verification method parameter and a verification range parameter for the database server, wherein the verification method parameter is used to indicate a computing device on which verification is to be performed, and wherein the verification range parameter comprises a block height or a hash value, and is used to determine a range of a to-be-verified data block or a data record in the ledger;
determining, by the database server, the computing device on which verification is to be performed, based on the verification method parameter; and
determining, by the database server, to-be-verified data based on the verification range parameter, wherein the to-be-verified data comprises one of a data record, a data block, a partial ledger, or an entire ledger.

18. The computer-readable medium according to claim 17, the operations further comprising:
in response to the verification method parameter indicating that verification is to be performed on the database server:
determining, by the database server, that verification is to be performed on the database server;
verifying, by the database server, integrity of the to-be-verified data; and
returning, by the database server, a verification result to the client.

19. The computer-readable medium according to claim 17, the operations further comprising:
in response to the verification method parameter indicating that verification is to be performed on the client:
determining, by the database server, that verification is to be performed on the client;
sending, by the database server and to the client, the to-be-verified data for verification by the client.

20. The computer-readable medium according to claim 19, wherein sending the to-be-verified data for verification by the client comprises:
determining, by the database server, other auxiliary verification data for use by the client when verifying the to-be-verified data, and sending the to-be-verified data and the other auxiliary verification data to the client.
